(19) United States
(12) Patent Application Publication
(10) Pub. No.: US 2023/0138525 A1
(43) Pub. Date: May 4, 2023

(54) Steel Stamp Box

(71) Applicant: Ying-Che Liao, Taichung City (TW)

(72) Inventor: Ying-Che Liao, Taichung City (TW)

(21) Appl. No.: 17/515,669

(22) Filed: Nov. 1, 2021

(51) Int. Cl. B65D 51/24; B65D 1/22

(52) U.S. Cl. CPC B65D 51/24; B65D 1/22

(57) ABSTRACT

A steel stamp box is configured to accommodate multiple steel stamps and contains: a cap. The cap includes an extension extending therefrom and at least one defining orifice vertically passing through the extension, such that one of the multiple steel stamps is selectively removed from a body, and the one steel stamp is fixed in the at least one defining orifice of the cap. Then, the cap is moved to confirm a stamping position of the one steel stamp so that the one steel stamp is tapped to stamp at least one text or symbol.

### BACKGROUND OF THE INVENTION

### Field of the Invention

The present invention relates to a stamping tool which is capable of avoiding tapping user’ s hand or workpiece to damage the user’ s hand and the material, and more particularly to a steel stamp box.

### Description of the Prior Art

To stamp at least one text or symbol on a workpiece made of metal or other rigid materials, a steel stamp is griped and is stamped on the workpiece with one hand, and the other hand holds a hammer to tap a top of the steel stamp until at least one text on a bottom of the steel stamp is stamped on the workpiece.

However, tapping the user’ s hand or the workpiece will happen often, so damage occurs to the user’ s hand or the workpiece. Furthermore, the steel stamp has to be replaced after worn/torn for a period of using time. It is troublesome and danger to tap the steel stamp.

The present invention has arisen to mitigate and/or obviate the afore-described disadvantages.

### SUMMARY OF THE INVENTION

The primary object of the present invention is to provide a steel stamp box which is capable of stamping at least one text or symbol safely, quickly, and accurately.

Another object of the present invention is to provide a steel stamp box which contains a hollow portion formed on an extension of the cap so as to move a cap and to confirm a stamping position accurately by using the hollow portion, thus stamping the at least one text exactly.

To obtain above-mentioned aspects, a steel stamp box provided by the present invention contains: a body, a cap, and multiple steel stamps.

The body includes an accommodation chamber configured to receive the multiple steel stamps, and the cap is covered on the body to storage the multiple steel stamps.

The cap includes an extension extending from an edge thereof, at least one defining orifice formed and passing through the extension, such that one of the multiple steel stamps is removed from the body and is fixed in one of the at least one defining orifice so that the cap is moved to a stamping position to tap the one steel stamp until at least one text on a bottom of the one steel stamp is stamped.

### BRIEF DESCRIPTION OF THE DRAWINGS

FIG. 1 is a perspective view showing the assembly of a steel stamp box according to a preferred embodiment of the present invention.

FIG. 2 is a perspective view showing the exploded components of the steel stamp box according to the preferred embodiment of the present invention.

FIG. 3 is a cross sectional view showing the assembly of the steel stamp box according to the preferred embodiment of the present invention.

FIG. 4 is a perspective view showing the operation of the steel stamp box according to the preferred embodiment of the present invention.

FIG. 5 is a cross sectional view showing the operation of the steel stamp box according to the preferred embodiment of the present invention.

FIG. 6 is a perspective view showing the assembly of the steel stamp box according to a first embodiment of the present invention as shown in FIG. 4.

FIG. 7 is a perspective view showing the exploded components of the steel stamp box according to the first embodiment of the present invention as shown in FIG. 6.

FIG. 8 is a perspective view showing the assembly of the steel stamp box according to a second embodiment of the present invention.

FIG. 9 is a perspective view showing the exploded components of the steel stamp box according to the second embodiment of the present invention.

FIG. 10 is another cross sectional view showing the operation of the steel stamp box according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

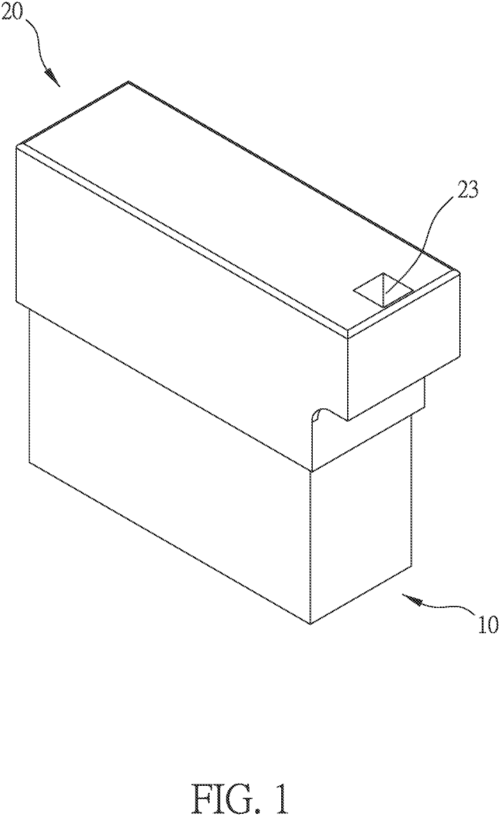

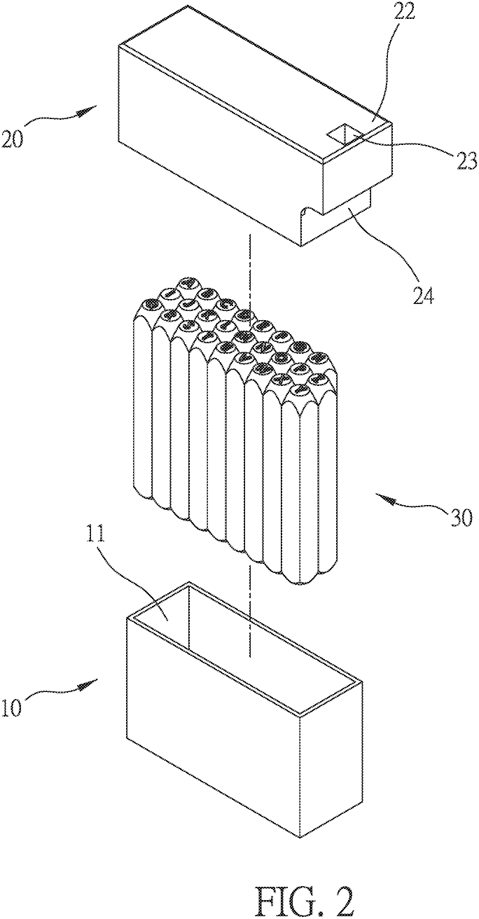

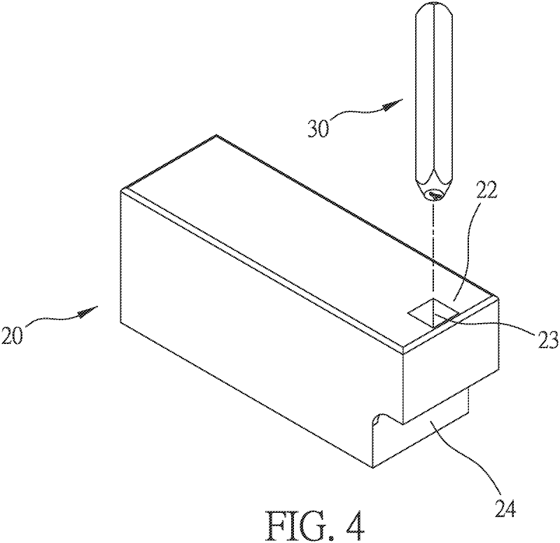

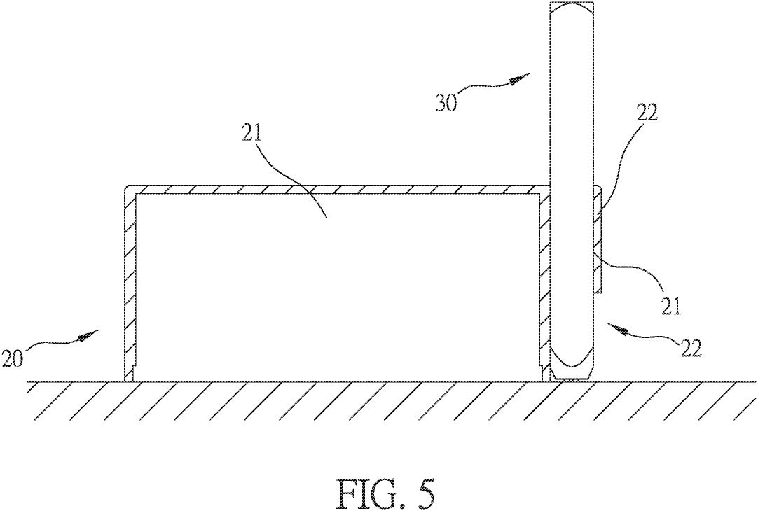

With reference to FIGS. 1-10, a steel stamp box according to a preferred embodiment of the present invention comprises:
a body 10 being a cuboid shape and including a rectangular accommodation chamber 11 defined in the body 10;
a cap 20 covering the rectangular accommodation chamber 11 of the body 10 and including a rectangular covering chamber 21 configured to accommodate the body 10, an extension 22 extending from a short edge of at least one short edge of the cap 20, at least one defining orifice 23 formed in a square shape and vertically passing through the extension 22, and a hollow portion 24 being concaved, formed on an end of the extension 22 and facing the body 10; and
multiple steel stamps 30 formed in a square prism shape and received in the rectangular accommodation chamber 11 of the body 10, and the rectangular accommodation chamber 11 of the body 10 being covered by the cap 20.

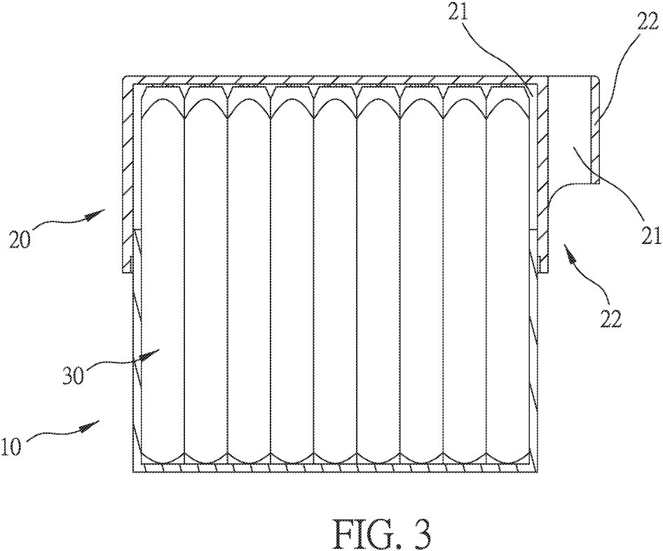

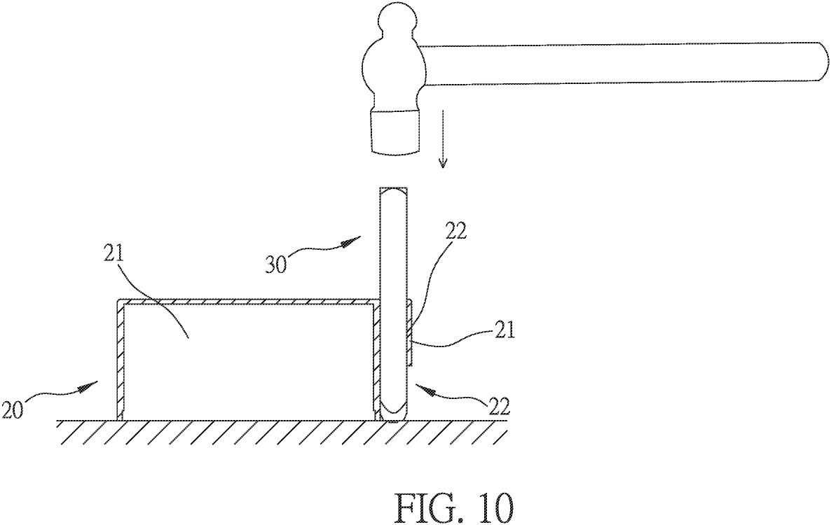

Referring to FIGS. 3-5, in use, the cap 20 is removed from the body 10, and one of the multiple steel stamps 30 is selectively removed from the rectangular accommodation chamber 11 of the body 10 (the multiple steel stamps 30 have at least one text or symbol, and the at least one text is Chinese, number or English), then the one steel stamp 30 is fixed in the at least one defining orifice 23 of the extension 22 of the cap 20, as shown in FIG. 10, such that the cap 20 is moved to confirm a stamping position of the one steel stamp 30, and the one steel stamp 30 is tapped to stamp the text or symbol. Thereby, the user grips one end of the cap 20 away from an end of the one steel stamp 30 to tap the one steel stamp 30 safely, quickly, and accurately, thus stamping the complete texts or symbols.

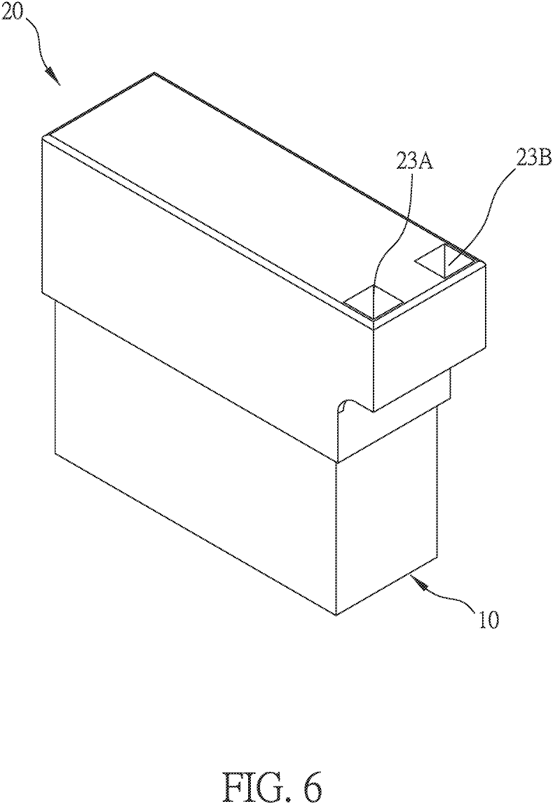

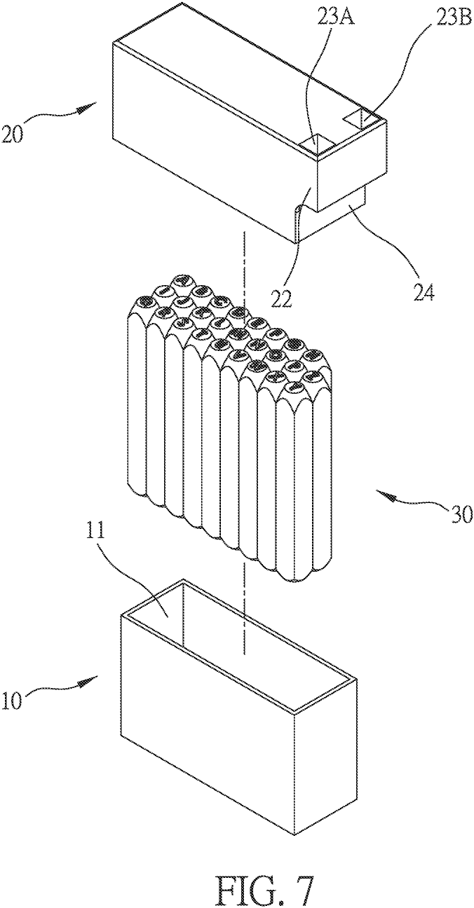

With reference to FIGS. 6-7, in a first embodiment, a first defining orifice 23A and a second defining orifice 23B are formed on the extension 22 of the cap 20 in a square shape and vertically passing through the extension 22, such that the user places the one steel stamp 30 in the first defining orifice 23A or the second defining orifice 23B of the extension 22 of the cap 20 so that the cap 20 is moved to confirm the stamping position of the one steel stamp 30 by using the hollow portion 24, thus tapping the one steel stamp 30 easily.

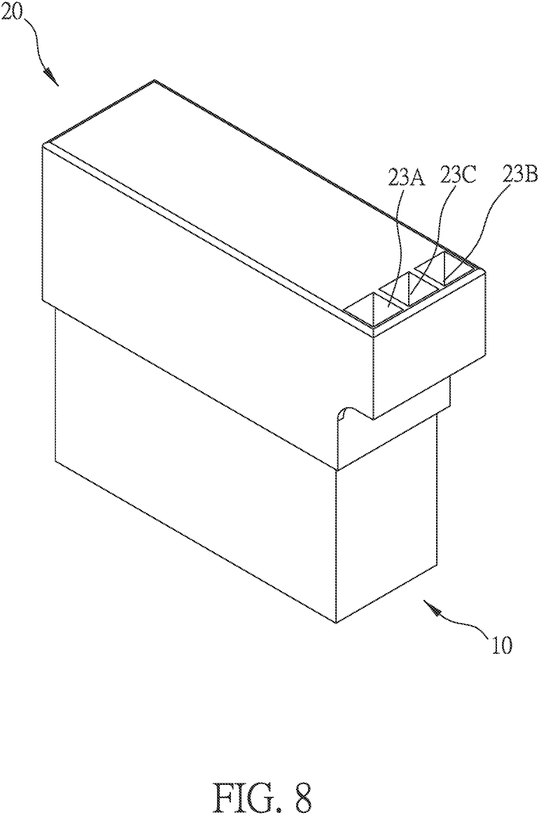

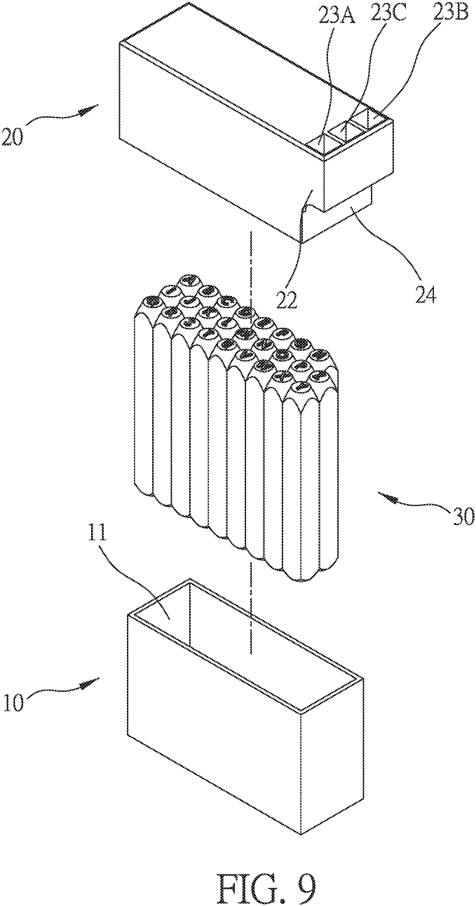

As illustrated in FIGS. 8 and 9, in a second embodiment, a first defining orifice 23A, a second defining orifice 23B and a third defining orifice 23C are formed on the extension 22 of the cap 20 in a square shape and vertically passing through the extension 22, such that the user places the one steel stamp 30 in the first defining orifice 23A, the second defining orifice 23B or the third defining orifice 23C of the extension 22 of the cap 20 so that the cap 20 is moved to confirm the stamping position of the one steel stamp 30 by using the hollow portion 24, thus tapping the one steel stamp 30 easily.

While various embodiments in accordance with the present invention have been shown and described, it is clear to those skilled in the art that further embodiments may be made without departing from the scope of the present invention.

1. A steel stamp box configured to accommodate multiple steel stamps and comprising:
a cap including an extension extending from the cap, and the cap including at least one defining orifice vertically passing through the extension, such that one of the multiple steel stamps is selectively removed from a body, the one steel stamp is fixed in the at least one defining orifice of the cap, then the cap is moved to confirm a stamping position of the one steel stamp, and the one steel stamp is tapped to stamp at least one text or symbol.

2. The steel stamp box as claimed in claim 1, wherein the extension of the cap has a hollow portion formed on an end thereof, such that the cap is moved to confirm the stamping position of the one steel stamp by using the hollow portion, and the one steel stamp is tapped.

3. The steel stamp box as claimed in claim 1, wherein the extension has two defining orifices.

4. The steel stamp box as claimed in claim 1, wherein the extension has three defining orifices.

5. A steel stamp box comprising:
a body including an accommodation chamber defined in the body;
a cap covering the accommodation chamber of the body and including a covering chamber configured to accommodate the body, an extension extending from an edge of the cap, at least one defining orifice vertically passing through the extension, and a hollow portion formed on an end of the extension and facing the body; and
multiple steel stamps received in the accommodation chamber of the body, and the cap being covered on the accommodation chamber of the body.

6. The steel stamp box as claimed in claim 5, wherein the extension extends from a short edge of at least one short edge of the cap.

7. The steel stamp box as claimed in claim 5, wherein the body is a cuboid shape.

8. The steel stamp box as claimed in claim 5, wherein the hollow portion is concaved.

9. The steel stamp box as claimed in claim 5, wherein the at least one defining orifice is a square shape and the multiple steel stamps are a square prism shape.

10. The steel stamp box as claimed in claim 5, wherein the extension has two defining orifices.

11. The steel stamp box as claimed in claim 5, wherein the extension has three defining orifices.
